(19) United States
(12) Patent Application Publication
(10) Pub. No.: US 2009/0099907 A1
(43) Pub. Date: Apr. 16, 2009

(54) PERFORMANCE MANAGEMENT

(75) Inventor: Matthew B. Wall, Cambridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Oculus Technologies Corporation, Boston, MA (US)

(21) Appl. No.: 12/250,863

(22) Filed: Oct. 14, 2008

Related U.S. Application Data
(60) Provisional application No. 60/998,950, filed on Oct. 15, 2007.

(51) Int. Cl. G06F 11/34

(52) U.S. Cl. 705/11

(57) ABSTRACT

A computer method and apparatus address the problem of objectively measuring the performance of a system composed of many different components. The present invention method/apparatus defines quantitative requirements representing the desired behavior of the components. Next, the method/apparatus determines acceptability levels by comparing the defined quantitative results to the actual measurements from the subject system to produce acceptability scores of the components. The present invention aggregates the acceptability scores to form a performance hierarchy of the components, where the hierarchy indicates the functional relationship between the overall system performance and the performance of the individual components.

### RELATED APPLICATION

This application claims the benefit of U.S. Provisional Application No. 60/998,950, filed on Oct. 15, 2007.

The entire teachings of the above application are incorporated herein by reference.

### BACKGROUND OF THE INVENTION

Many systems have some measure of performance. However, many definitions of performance are poorly structured or ill-defined. In some cases, they may work well for development or testing, but fail when used in a production environment. In other cases, they work for a period of time, but cannot be used at a later date when the performance criteria change. In still other cases, weighting factors may indicate good results in one case and terrible results from a similar but slightly different case. A framework for defining and aggregating scores is useful not only for assessing system performance, but also for configuring trade studies, search, and optimization. In many cases, such a framework is not just useful, but essential.

For example, consider assigning an objective score to the problem of shipping goods effectively: in one case, the total cost of shipping might be the score of interest. The total cost depends on factors such as the amount of fuel required, the wear and tear on the vehicles, and the wages of the personnel. These factors are metrics: observable quantities associated with different components of the system. To get the total cost, one sums the metrics, each weighted by their respective prices:

Total Cost=Fuel×w₁+Vehicles×w₂+Labor×w₃,

where w₁ is the price of fuel in dollars per gallon, w₂ is the depreciation rate of the vehicles in dollars per mile traveled, and w₃ is the wages in dollars per hour. Each weight assigns a value to its associated component metric and translates that metric into a common unit (dollars, in this case). Here, the goal is to minimize the score—reducing cost is the driving concern.

Although cost is often a very useful measure of performance, there might be more important considerations in other cases. For example, when shipping certain types of goods—e.g., perishable goods or time-sensitive documents—maximizing speed is more important than minimizing cost. In other words, scores are not necessarily robust across multiple problem configurations. A more sophisticated score might incorporate both cost and speed, provided that these metrics are converted into unitless quantities and normalized appropriately.

Even with the appropriate weights and conversions, certain aggregations of metrics might result in nonsensical scores. In this example, both the labor time and the amount of fuel should remain about the same as speed increases, leading to a higher score (assuming that high scores are good). The total cost would most likely be much higher, something that would not be reflected in a score generated from the equation above. In general, then, the formula, weights, and components used to define a score affect the robustness of the score.

### SUMMARY OF THE INVENTION

The present invention addresses the disadvantages and concerns of the prior art. In particular, the present invention provides a performance management tool for assessing the performance of a system based on the aggregated performance of the system's components.

In a preferred embodiment, a performance manager is implemented as a computer method and apparatus for measuring and managing system performance. The performance manager allows the user to translate system requirements for the behavior of system components into numerically defined preferences, which can be represented graphically in a certain screen view. The performance manager provides to the user an interface for entering performance data for each system component. The performance manager normalizes and converts these data into acceptabilities, which can also be represented graphically in certain screen views.

In a preferred embodiment, the performance manager aggregates the various preference and performance data to provide a quantitative measure of overall system performance. The aggregated data can be viewed according to various hierarchical and cluster-oriented representations, such as tables presenting hybrid textual and graphical representations or fully graphical representations. By studying and manipulating the hierarchical and cluster-oriented representations of system performance, the user can determine the functional relationship between the performance of the system components and the performance of the system as a whole.

Example embodiments of the performance manager (performance management tool) can be used to represent many industry requirements, from Leadership in Energy and Environmental Design (LEED) in the construction industry to various certifications, such as those from Underwriters Laboratories (UL) or the International Organization for Standardization (ISO).

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a preference viewer of the present invention used to define and visualize the mapping between a metric space and a unitless performance space.

FIG. 2A is a schematic view of a user interface used to define and visualize deterministic simulation results, experimental data, or other collected actual performance results associated with a component metric.

FIG. 2B is a schematic view of a user interface used to define and visualize a probability density function (PDF) associated with a component metric.

FIG. 2C is a schematic view of a user interface used to define and visualize a histogram associated with a component metric.

FIG. 3 is a schematic view of a user interface used to visualize an acceptability, which, in this case, is a comparison between the preference curve shown in FIG. 1 and the PDF shown in FIG. 2C.

FIG. 4A is a schematic view of a user interface used to visualize as a hierarchy an aggregation of the preference curves and probability density functions for several components.

FIG. 4B is a schematic view of a user interface used to visualize as a spider plot the aggregation of the preference versus performance for the components shown in FIG. 4A.

FIG. 5 is a flow diagram of embodiments of the present invention.

FIG. 6 is a schematic view of a computer network in which embodiments of the present invention may be implemented.

FIG. 7 is a block diagram of the computer nodes in the network of FIG. 6.

### DETAILED DESCRIPTION OF THE INVENTION

A description of example embodiments of the invention follows.

The preferred embodiment uses a framework for defining and aggregating quantitative requirements to obtain a numeric score of overall system performance. This objective score depends on the requirement for and performance of multiple components. The relationship between the score and the contributions to the score from each component is often referred to as an objective function. The results from the individual components and the overall objective function/score might be used to assess system performance, or they might be used in an optimization or a search algorithm. Alternatively, the results can be used to make comparisons of different scenarios, or of a single scenario against multiple sets of requirements.

Framework. The framework defines and enforces characteristics for analyzing component metrics using preferences, performances, and acceptability scores. The framework comprises: methods for defining metrics; methods for normalizing the metrics; methods for consistently converting metrics to unitless values; methods for consistently using probabilistic metrics; methods for generating preferences, performances, and acceptability scores for each component; and methods for comparing and aggregating the performances and preferences into scores.

Normalization. The metrics of many components may span ranges of values that are wildly different in magnitude than those of other components. To make meaningful comparisons of different metrics, the magnitudes of the metrics must be normalized. For example, the relevant metric for one component might range from 0-100%, while the relevant metric for another component might be on the order of a few parts per million. These ranges are both unitless, but several orders of magnitude apart. Normalizing these metrics makes it possible to compare them more reasonably and more meaningfully. Normalization also enables absolute comparison of scores, regardless of when or in which context the scores were calculated.

Units. Most metrics have units of some sort, although not necessarily common units. For example, dBm's are a measure of power normalized to 1 mW, while dBV's are a measure of voltage normalized to 1 V. Although the two measures are normalized, they are in incompatible units and thus cannot be directly compared or aggregated. To compare or aggregate these metrics, the metrics must be translated into common units.

Component Scores. Each system component has a score. The score is unitless and is in the interval of 0 to 1, inclusive, where higher scores indicate better performance. A score of 1 indicates perfectly good performance, whereas a score of 0 indicates perfectly poor performance. A component score might be arbitrarily assigned, or it could be an acceptability score or an aggregate score.

Acceptability Scores. The comparison of results against requirements yields an acceptability score. The score is unitless and is in the interval of 0 to 1, inclusive, where higher scores indicate better performance. A score of 1 indicates perfectly good performance, whereas a score of 0 indicates perfectly poor performance.

Aggregation. The component scores (e.g., acceptability scores) may be aggregated from any combination of component metrics using algorithms such as weighting or averaging, but they always result in a unitless score that is in the 0 to 1 interval, inclusive. When weights are used, they are used consistently. Treating subsystems as components in an overarching system allows the acceptability scores of the subsystems to be aggregated into a score for the overarching system. Since it is unitless and normalized to the interval 0 to 1, an aggregate score can be used as a component score within a larger aggregation.

Probabilities. In traditional decision-making methods, the expected value drives the decision; the expected value indicates the most likely outcome. When the results have variance, not just an expected value, the framework enables assessment of risk and opportunity, not just expected value and variance. Considering the variance in addition to expected value provides insight into the robustness of the expected outcome. In the preferred embodiment, the foundation for this assessment is mean-semivariance analysis, although those skilled in the art will understand that other types of analysis can be used as well.

### Using the Framework

Key to embodiments of the present invention is a performance hierarchy. Creating a performance hierarchy comprises three steps: (1) defining preferences for each component metric; (2) determining acceptability scores by comparing the preferences to component performances for a given scenario; and (3) aggregating the resulting component scores. This three-step process enables a significant fourth step of the invention: forming a performance hierarchy of one or more components from the aggregated results. Studying this performance hierarchy allows the user to discern the functional relationships between the overall system performance and the performance of the system components. In addition, the topology of the performance hierarchy can be used to identify compatible sets of results and/or compatible sets of requirements.

The overall system score is created by mapping a requirements hierarchy onto a hierarchy of acceptabilities, then copying or linking the preference curves in the requirements hierarchy to the performance numbers from a simulation and/or experimental results. The simulation and/or experimental results can be deterministic, probabilistic, or both. This structure enables one to easily change metrics, for example, to compare how a simulation of a building's energy use performs relative to US energy policies versus European standards.

### Requirements and Preferences

System requirements specify how a system should behave in a given scenario. To incorporate requirements into the framework described above, the requirements, which are often qualitative, must be translated into quantitatively defined preferences. The framework of the present invention only works for quantifiable requirements. Requirements that are expressed as text or images must be mapped into quantitative measures in order to be used in the framework of the present invention.

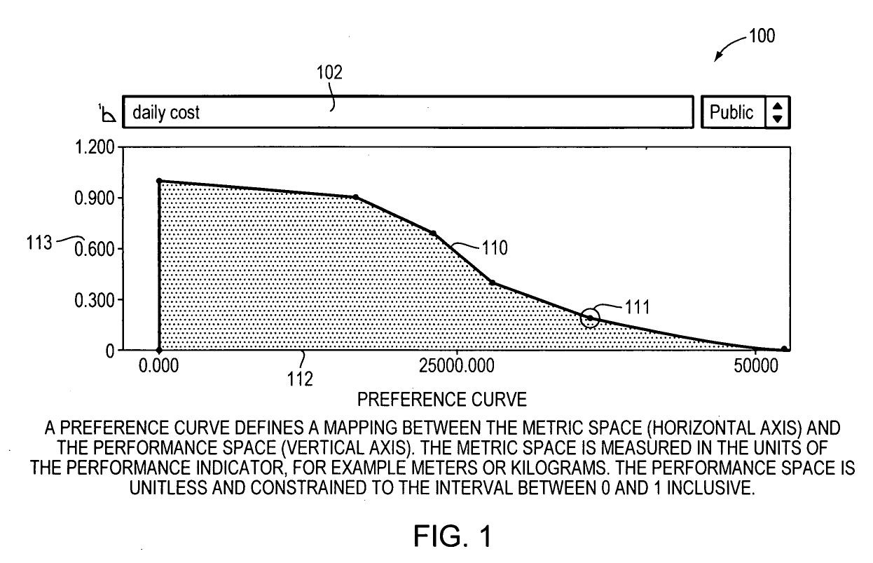

Once the requirements have been quantitatively defined, they can be represented as preference curves. For example, FIG. 1 shows a preference viewer 100 in embodiments of the present invention. The preference viewer 100 enables a user to visualize a preference curve 110 for a metric-in this example, “daily cost.” A field 102 allows the user to name a component metric.

The preference curve 110, which can be defined as a series of points 111, maps a value onto a performance axis 113, which spans the unitless interval of scores [0,1], from a metric axis 112, which may have units. The higher the score, the better the system performance, with 1 being a perfect score. The metric space is measured in units of the performance indicator, for example, meters or kilograms. The performance space (i.e., vertical axis 113) is unitless.

Preferences curves may be grouped and organized into arbitrary clusters and hierarchies. The hierarchy typically implies dependency, where the root level of the hierarchy will be the aggregate of requirements nested in the hierarchy.

### Results and Performance

Comparing the actual system performance (results) to the desired system performance (preferences) necessitates acquiring the values of the component metrics for a given scenario. These values, or “actual performance results,” may be generated through simulation, collected from experimental data, or manually assigned. Results may be single numbers, vectors, or arrays, and may or may not have units. Some results may be deterministic, such as the amount of steel required to build a structure with given dimensions, while others may be probabilistic, such as the yield of a computer chip manufacturing process.

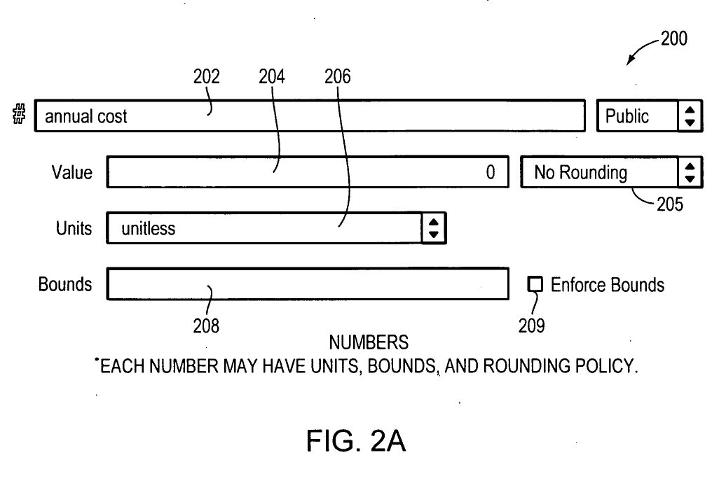

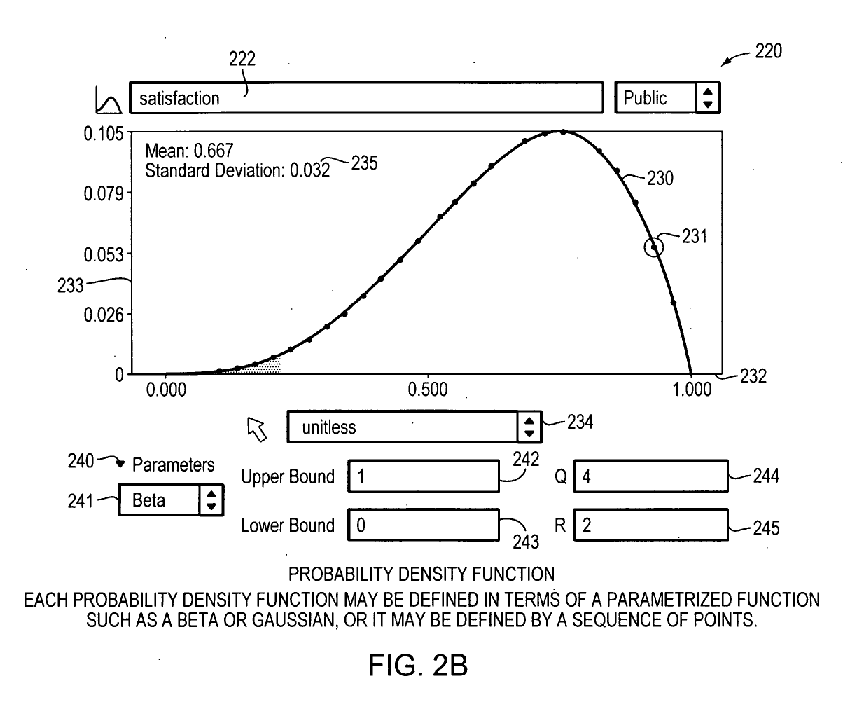

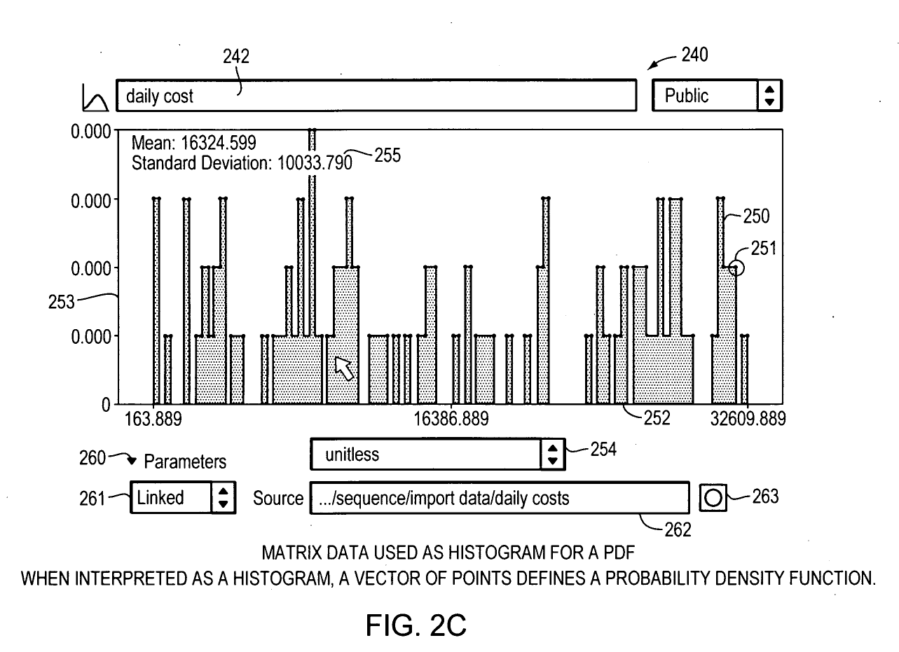

FIG. 2A shows a schematic of a user interface 200 for entering such actual (i.e., measured or otherwise acquired) performance results into a performance manager of embodiments of the present invention. The user specifies a name for the component metric using a component metric field 202 and enters the associated result value into a value field 204. The user interface 200 further enables the user to choose a rounding policy with a rounding policy selector 205. The user can further specify units to apply to the value field 204 values with a unit selector 206, bounds on the range of values with a bounds selector 208, and a bounds enforcement policy using a bounds enforcement checkbox 209.

Whereas deterministic results may be represented by single numbers, probabilistic results are usually represented by probability density functions (PDFs). The present invention provides a PDF viewer 220 for visualizing PDFs as shown in the schematic view of FIG. 2B. The PDF may be represented as a parameterized PDF curve 230 or as a sequence of points 231 that map the results associated with a given metric displayed in a metric display field 222 from a metric axis 232 onto a probability axis 233. A unit selector 234 allows the user to select units for the metric axis 232, and a statistics display 235 shows the mean and standard deviation of the PDF. A parameter display 240 shows a function selector 241 for selecting parameterized PDFs such as Beta, Gamma, Uniform, or Gaussian functions. Various types of PDFs are parameterized using different values. For example, a uniform PDF is defined by three values: a lower bound, and upper bound, and a likelihood. A Beta PDF is defined by four values: an upper bound, lower bound, ‘R’ value, and ‘Q’ value. The PDF viewer 220 includes controls for defining the upper bound (242), lower bound (243), ‘Q’ value (244), and ‘R’ value (245).

FIG. 2C is a schematic of another PDF viewer 240. In FIG. 2C, however, the PDF is given by the histogram 250 of a sequence of data points 251. As in FIG. 2B, the PDF maps a metric axis 252 to a probability axis 253. A unit selector 254 enables the user to select or otherwise set units for the metric axis 252. Because the PDF is defined as the histogram 250 of a sequence of data points 251 instead of a parameterized function, however, the parameter display 260 shows a source type selector 261 and an accompanying source field 262 for entering the source of the data points. Icon 263 is a handle to a user interface for browsing data sources. A statistics display area 255 indicates the mean and standard deviation of the PDF.

### Acceptability and Acceptability Score

An acceptability is the comparison between the actual performance results, which are acquired values (described above), and the desired performance, which is specified by a preference curve. Each acceptability requires two inputs: a preference curve and a performance value. The comparison of the preference curve and performance value results in the acceptability score, which is unitless and in the interval [0,1]. The acceptability score is always an expected value and may include a variance.

The preferred embodiment uses a mean-semivariance approach to calculate the risk and opportunity (i.e., the semivariance), which are indications of robustness. The risk is the downside of the variance, whereas the opportunity is the upside of the variance. When the performance is deterministic, the risk and opportunity are both zero. When the performance is probabilistic, the risk and opportunity may be non-zero. A symmetric PDF applied to a uniform preference curve has equivalent risk and opportunity.

In one embodiment, the algorithm for calculating the acceptability score is:

$${σ}^{2} = {r}^{2} + {o}^{2}$$

$${σ}^{2} = \frac{1}{n} {\sum }_{i = 1}^{n} {[ {x}_{i} - E ( {x}_{i} ) ]}^{2}$$

$${o}^{2} = E ( max {\{ 0 , a ( {x}_{i} ) - E [ a ( {x}_{i} ) ] \}}^{2} )$$

$${r}^{2} = E ( min {\{ 0 , a ( {x}_{i} ) - E [ a ( {x}_{i} ) ] \}}^{2} )$$

where x is a random variable (from the performance distribution), a(x) is the preference function for x, and E[a(x)] denotes the expectation value of x.

When the components have been defined using the framework of the present invention, they can be compared with any other component, regardless of units or magnitude, or deterministic or probabilistic nature.

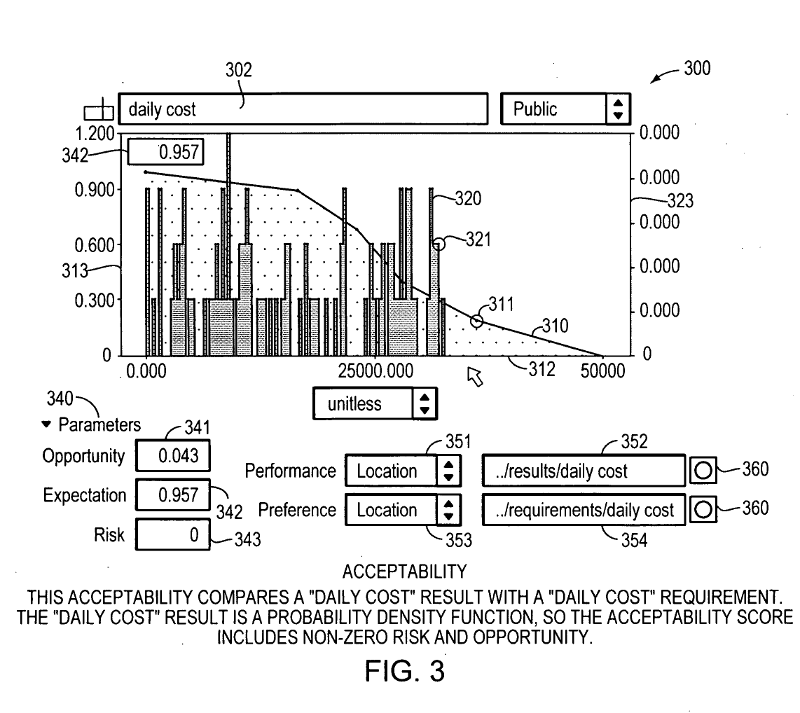

FIG. 3 shows a schematic of an acceptability viewer 300 for comparing the preferences and performances associated with a single component. The user selects the metric to view using a component field 302. The viewer 300 shows a preference curve 310 for the subject component determined by a set of associated points 311 and a PDF curve 320 of the subject component overlaid on the preference curve 310. In this case, the PDF curve 320 is the histogram defined by a set of points 321 shown in FIG. 2C. The preference curve 310 maps a metric axis 312 to a performance axis 313, whereas the performance curve 320 maps the metric axis 312 to a probability axis 323. A score indicator 342 shows the score for the subject component (daily cost in this example).

Specifically, the score indicator 342 shows the expected value resulting from a comparison of daily cost actual (measured or otherwise acquired) performance results with a daily cost requirement (preference). The daily cost performance result is given here as a PDF 320, so the acceptability score indicator 342 reports non-zero risk 343 and opportunity 341.

A parameter display 340 shows an opportunity field 341, an expectation field 342, and a risk field 343, each of which display values calculated using semi-variance analysis in the preferred embodiment. Of course, other analyses can be used to calculate similar measures.

A performance type selector 351 is set to “Location,” and a performance location selector field 352 shows the path to the results used to generate the current PDF 320. A preference type selector 353 is set to “Location,” and a preference location selector field 354 shows the path to the requirements used to generate the preference curve 310. Icons 360 are handles to a user interface for browsing performances and preferences. The type selectors can specify a performance and/or preference directly, in which case the location selector fields are replaced with fields for specifying performance and preference parameters directly.

### Aggregation

As described above, the overall system score is a function of one or more component scores. The component scores, like the system score, are unitless and in the interval [0,1]. Each component score may be an acceptability from a single component metric, an aggregation of other component scores, or a manually assigned value. In the preferred embodiment, the component scores are aggregated using the average, weighted average, or product methods to yield the system score.

Given n components, each having a score cᵢ and a weight wᵢ where i is the component index, the algorithms for calculating aggregate scores according to the methods listed above are:

$$Average \text{:} s = \frac{1}{n} {\sum }_{i = 1}^{n} {c}_{i} ;$$

$$Weighted Average \text{:} s = \frac{1}{n} {\sum }_{i = 1}^{n} \frac{{w}_{i} {c}_{i}}{{w}_{i}} ;$$

$$Product \text{:} s = {\prod }_{i = 1}^{n} {c}_{i} .$$

These methods are mutually exclusive; when aggregating components, only one method can be used at a given level of the system hierarchy. However, different methods may be used concurrently at different levels in the system hierarchy.

Perhaps the most common approach to combining metrics is weighted averaging. In this approach, each component is multiplied by a weight then added to the other weighted components. The sum is then divided by the weighted sum.

Weights provide common direct handles for manipulating the importance of one component relative to another. When weights are used for this purpose, they are entirely appropriate. However, weights are often used incorrectly to adjust the raw magnitudes of each component. When used in this manner, they quickly become arbitrary, causing system evaluation to become brittle.

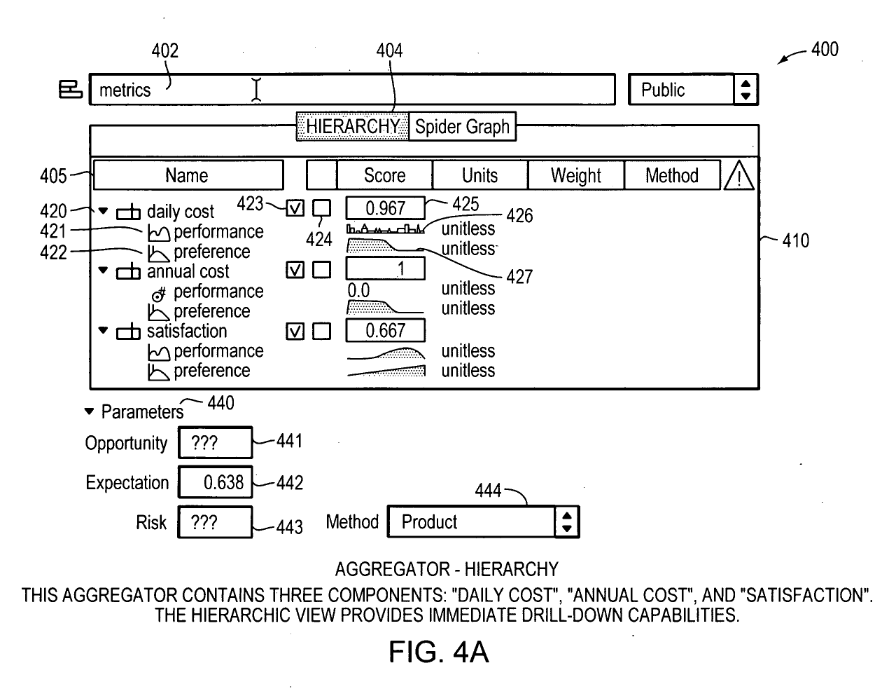

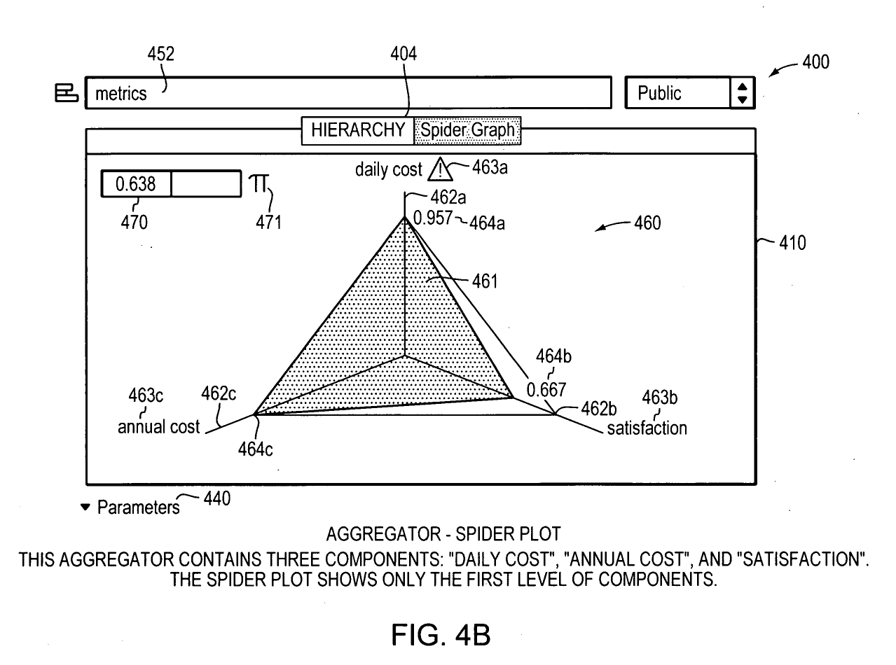

FIG. 4A shows a schematic of an aggregation viewer 400 for viewing the aggregated preferences and performances. A display 402 shows the name of this aggregation, which is “metrics” in this case. An aggregation view selector 404 allows the user to select from a hierarchy view 410 shown in FIG. 4A or a spider graph view 450 shown in FIG. 4B and described below. In the hierarchy view 410 shown in FIG. 4A, a column header 405 organizes the relevant parameters into columns. Each row lists a different metric 420. Acceptabilities in the hierarchy can be broken out into a performance sub-row 421 and a preference sub-row 422. In the illustrated example, three components (metrics) are hierarchically listed. They are labeled, “daily cost,” “annual cost,” and “satisfaction,” each with respective performance-preference pairs of graph data (next levels in the hierarchy). Checkbox 423 allows the user to selectively enable or disable a component; if a checkbox is ticked, that component will be included in the calculation of the aggregate score. Colored indicators 424 show the expected value of the score for each component, with scores of 0 as red and scores of 1 as green.

For each component (metric), a score indicator 425 shows the respective component score (e.g., acceptability score 342, FIG. 3) for a metric 420, whereas a performance indicator 426 and a preference indicator 427 show thumbnails of the performance and preference curves, respectively, used to compute a score 425.

A parameter display 440 shows an opportunity field 441, an expectation field 442, and a risk field 443, each of which show values for the aggregate calculated using semi-variance analysis in the preferred embodiment. A method selector 444 allows the user to choose from average, weighted average, and product aggregation methods.

FIG. 4B shows a schematic view of the aggregation viewer 400 in spider graph mode, as indicated by the aggregation view selector 404. A spider graph 460 shows system score as a function of plot area 461; the larger the highlighted area, the higher the score. The plot area 461 stretches along component axes 462a-c to respective component scores 464a-c. Each component axis 462a-c has its own axis label 463a-c. The additional warning symbol next to icon 463a indicates a constrained, invalid, or incomplete score for ‘daily cost’. A score indicator 470 shows the aggregate score, and an aggregation method icon (or symbol or other indicator) 471 shows the aggregation method (e.g., Π indicates the product method). FIG. 4B shows a collapsed view of the parameter display 440. Note, the spider graph view 460 only shows the first level of the component data where the hierarchy view 410 (FIG. 4A) includes other levels.

### Dominance and Annihilation

When aggregating metrics using the average or product methods, one must beware of dominance and annihilation, respectively. Dominance occurs in averaging when a single score is much greater or smaller than the other scores. Normalizing the component metrics to the interval [0,1] reduces the effects of dominance in most cases, but dominance can still occur.

When aggregating scores using the product method, a single low score may annihilate the other high scores (e.g., multiplying nonzero scores by a score of zero produces an aggregate score of zero). Once again, normalizing components to the interval [0,1] reduces the effects of annihilation, but annihilation can still occur.

In some instances, annihilation may be desirable. If a single component is perfectly bad (i.e., it has a score of 0) and the entire system performance requires that all components perform satisfactorily, then the perfectly bad score annihilates the scores of the other components, resulting in a system score of 0. To avoid deleterious instances of annihilation or dominance, the chosen aggregation method should match the nature of the interaction of the components that make up the system.

### Method Overview

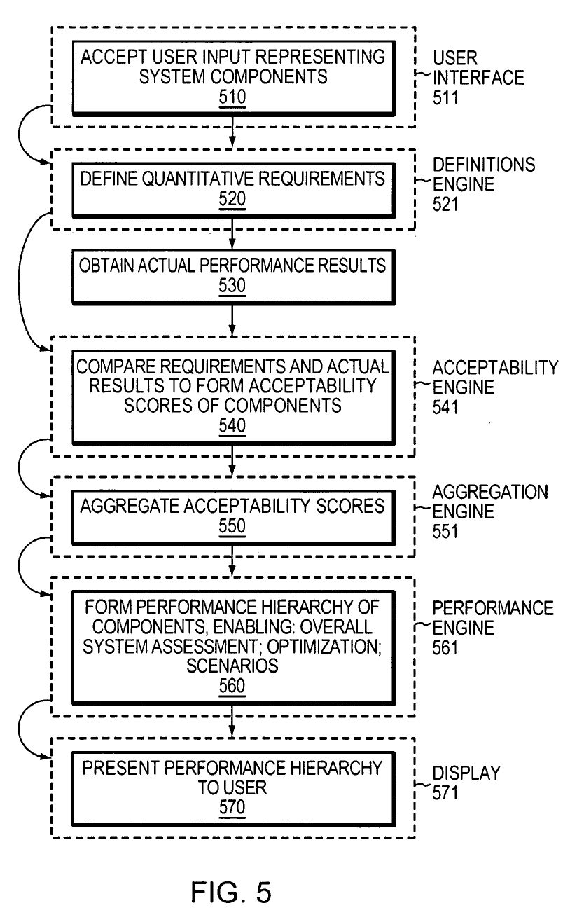

FIG. 5 shows a flow diagram that illustrates a process 500 for measuring system performance according to embodiments of the present invention. The process 500 begins with defining requirements (710) for acceptable and unacceptable system performance. Once the requirements have been defined, actual performance results can be obtained (720). For example, the user can enter the results in the user interface 200 shown in FIG. 2A. In some cases, the performance results may be collected from real-world systems; in other cases, the performance results may be simulation or model results. The results can be viewed in PDF viewers 220 and 240 of FIGS. 2B and 2C, respectively.

Next, the results are compared to the requirements to form acceptability scores of the components that make up the system (730). In some embodiments, the results are compared to the requirements in an acceptability viewer, such as the acceptability viewer 300 shown in FIG. 3. The acceptability scores are then aggregated to form a performance hierarchy of system components (740), which may viewed using the aggregation viewer 400 shown in FIGS. 4A and 4B.

Finally, the performance hierarchy may be manipulated to assess or optimize the overall system performance (750). For example, the hierarchical view can show the importance (or unimportance) of a given system component relative to the system as a whole. In addition, the system may be tested under different scenarios using the performance hierarchy to view the relationship among the system components and between the components and the overall system as a function of operating conditions or parameters.

A key part of this invention is the non-modality of the method. Although the previous paragraphs outline a specific series of steps for creating a performance hierarchy, the structure of the framework enables one to create and maintain performance hierarchies in other ways. For example, in a requirements-driven environment one would first create the requirements hierarchy, then create the acceptability hierarchy to match it, then apply the results. In a results-drive environment, one could create a hierarchy of acceptabilities, then apply various preference curves.

### Physical Implementation

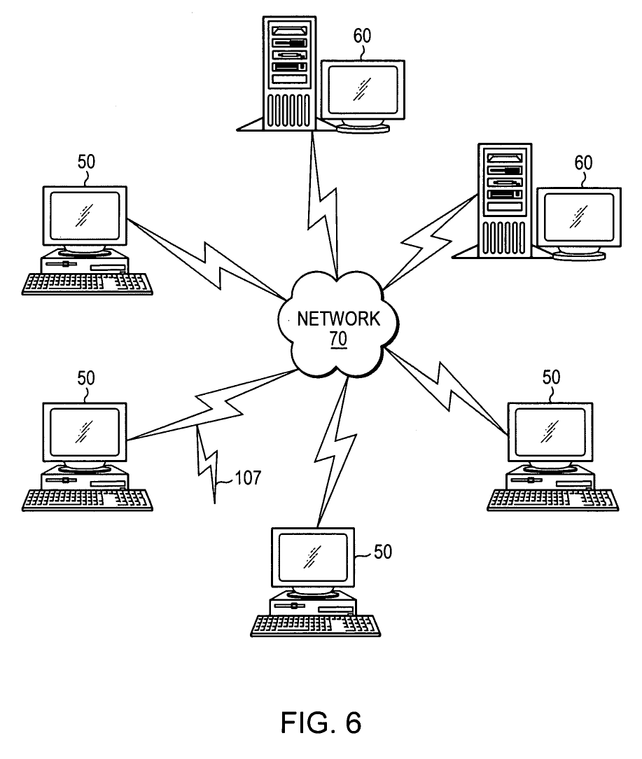

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

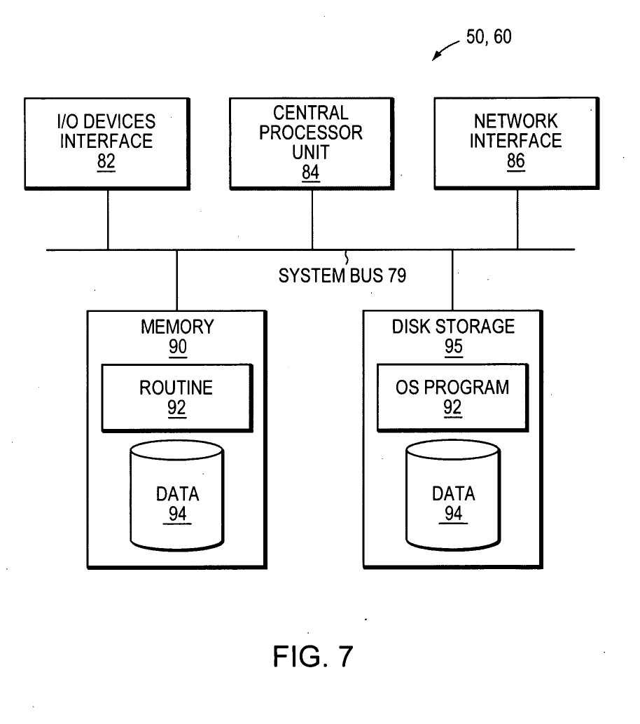

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention. Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Given the foregoing description, it should be apparent that example embodiments of the present invention can be used to represent many industry requirements. For example, the performance manager can be used to evaluate buildings according to the Leadership in Energy and Environmental Design (LEED) standards promulgated by the Natural Resources Defense Council and the U.S. Green Building Council. The performance manager can also be used to determine how to structure manufacturing and safety standards, such as those from Underwriters Laboratories (UL) or the International Organization for Standardization (ISO).

While this invention has been particularly shown and described with references to example embodiments thereof, it will be understood by those skilled in the art that various changes in form and details may be made therein without departing from the scope of the invention encompassed by the appended claims.

What is claimed is:

1. A computer-based method for measuring system performance comprising:
(a) for each of one or more components,
(i) defining quantitative requirements representing desired behavior of the component,
(ii) determining acceptability levels by comparing the defined quantitative requirements to actual results from a subject system, the comparing producing acceptability scores of the component, and
(iii) aggregating the produced acceptability scores;
(b) using a digital processor, forming a performance hierarchy from the aggregated acceptability scores of the one or more components, the formed performance hierarchy indicating functional relationship between an overall system performance score of the subject system and contributions to the overall score from each component; and
(c) displaying as output to a user the formed performance hierarchy.

2. The method as claimed in claim 1 wherein the comparing further produces a measure of overall system performance of the subject system.

3. The method as claimed in claim 1 wherein the formed performance hierarchy serves as an objective function, and results from the objective function are used to assess system performance of the subject system.

4. The method as claimed in claim 1 wherein the formed performance hierarchy serves as an objective function, and results from the objective function are used to optimize the subject system.

5. The method as claimed in claim 1 wherein the formed performance hierarchy serves as an objective function.

6. The method as claimed in claim 5 wherein results from the objective function are used to make comparisons of different scenarios.

7. The method as claimed in claim 5 wherein results from the objective function are used to compare performance of a single scenario against multiple sets of requirements.

8. The method as claimed in claim 5 wherein results from the objective function are used to drive a search process.

9. The method as claimed in claim 5 wherein results from the objective function are used to drive an optimization process.

10. The method as claimed in claim 1 wherein a topology of the formed performance hierarchy is used to identify compatible sets of results or compatible sets of requirements.

11. A computer apparatus for measuring system performance comprising:
a user interface that accepts input from a user, the input representing desired behavior of one or more components of a subject system;
a digital processor that:
(i) defines quantitative requirements representing desired behavior of the component,
(ii) determines acceptability levels by comparing the defined quantitative requirements to actual results from a subject system, the comparing producing acceptability scores of the component,
(iii) aggregates the produced acceptability scores, and
(iv) forms a performance hierarchy from the aggregated acceptability scores of the one or more components, the formed performance hierarchy indicating functional relationship between an overall system performance score of the subject system and contributions to the overall score from each component; and
a display that presents the formed performance hierarchy to the user.

12. The computer apparatus as claimed in claim 10 wherein the digital processor further produces a measure of overall system performance of the subject system.

13. The computer apparatus as claimed in claim 10 wherein the formed performance hierarchy serves as an objective function, and results from the objective function are used to assess system performance of the subject system.

14. The computer apparatus as claimed in claim 10 wherein the formed performance hierarchy serves as an objective function, and results from the objective function are used to optimize the subject system.

15. The computer apparatus as claimed in claim 10 wherein the formed performance hierarchy serves as an objective function

16. The computer apparatus as claimed in claim 15 wherein results from the objective function are used to make comparisons of different scenarios.

17. The computer apparatus as claimed in claim 15 wherein results from the objective function are used to compare performance of a single scenario against multiple sets of requirements.

18. The computer apparatus as claimed in claim 15 wherein results from the objective function are used to drive a search process.

19. The computer apparatus as claimed in claim 15 wherein results from the objective function are used to drive an optimization process.

20. The computer apparatus as claimed in claim 10 wherein a topology of the formed performance hierarchy is used to identify compatible sets of results or compatible sets of requirements.

21. A computer program product comprising:
a computer readable medium having a computer readable program, wherein the computer readable program when executed on a computer causes a computer to:
(a) for each of one or more components,
(i) define quantitative requirements representing desired behavior of the component,
(ii) determine acceptability levels by comparing the defined quantitative requirements to actual results from a subject system, the comparing producing acceptability scores of the component, and
(iii) aggregate the produced acceptability scores;
(b) form a performance hierarchy from the aggregated acceptability scores of the one or more components, the formed performance hierarchy indicating functional relationship between an overall system performance score of the subject system and contributions to the overall score from each component; and
(c) display as output to a user the formed performance hierarchy.
